(19) United States
(12) Patent Application Publication
(10) Pub. No.: US 2025/0068691 A1
(43) Pub. Date: Feb. 27, 2025

(54) MULTIPLE-PLAY MULTI-ARMED BANDITS METHOD AND APPARATUS FOR ENSURING EXPOSURE FAIRNESS OF ITEMS

(71) Applicant: POSTECH RESEARCH AND BUSINESS DEVELOPMENT FOUNDATION, Pohang-si (KR)

(72) Inventors: Youngmi JIN, Pohang-si (KR); Dong Deok KIM, Pohang-si (KR); Young Joo SUH, Pohang-si (KR)

(73) Assignee: POSTECH RESEARCH AND BUSINESS DEVELOPMENT FOUNDATION, Pohang-si (KR)

(21) Appl. No.: 18/799,915

(22) Filed: Aug. 9, 2024

(30) Foreign Application Priority Data
Aug. 14, 2023 (KR) 10-2023-0106224
Apr. 5, 2024 (KR) 10-2024-0046856

(51) Int. Cl. G06F 17/11

(52) U.S. Cl. CPC G06F 17/11

(57) ABSTRACT

The present disclosure relates to a multi-armed bandit method and apparatus for selecting multiple items while ensuring fairness of exposure of the multiple items and maximizing the averaged total reward. The MAB method includes: initializing the empirical mean reward and number of arm selections of each arm for the M arms, and the time step; incrementing the time step; calculating the UCB index of each arm for the M arms; selecting K−1 arms with the K−1 highest UCB indices calculated; calculating unfairness indices for the unchosen M−(K−1) arms; checking if there is an arm with a positive unfairness index among the unchosen M−(K−1) arms; selecting the remaining single arm depending on whether there is an arm with a positive unfairness index among the unchosen M−(K−1) arms; playing the selected K arms; and updating the empirical mean reward and the number of arm selections for the played arms.

### CROSS-REFERENCE TO RELATED APPLICATIONS

This application claims priority to Korean Patent Application No. 10-2023-0106224 filed on Aug. 14, 2023 and No. 10-2024-0046856 filed on Apr. 5, 2024 in Korea, the entire contents of each of which are hereby incorporated by reference in their entirety.

### TECHNICAL FIELD

The present disclosure relates to multi-armed bandit technology, and more specifically, to a multi-armed bandit method and apparatus for selecting multiple items while ensuring fairness of exposure of the multiple items and maximizing the averaged total reward.

### BACKGROUND

The multi-armed bandit (MAB) problem is a type of sequential decision-making problem. When there are multiple selection items, each selection item is referred to as an arm. There are multiple arms, and when each arm is played (or is chosen to play), a reward is generated for the played arm. The reward for each arm played is a random variable, and the reward can be different each time the arm is played. While no information is given about the random variables of the rewards for each arm, the specific reward is known when an arm is played. In this situation, when the opportunity to play an arm is given T times, at each time step t (1≤t≤T), the problem is to find which arm to play at each time step t to maximize the averaged total reward for the total time based on past information (history: which arm was selected and rewards that occur when the selected arms are played) of selected arms and their rewards during the past time steps t−1. In other words, given a total of T time steps and a choice of arms to play at each time step t (1≤t≤T), the problem is to determine which arms to play at each time step based on past information to maximize the averaged total reward earned at all-time steps. The multi-armed bandit problem is a classical machine learning algorithm that can be applied to a variety of fields, including recommender systems, finding secondary channels in cognitive radio, routing, and finding medical methods/drugs suitable for patients.

Traditionally, the objective of the multi-armed bandit is to maximize the averaged total reward at all-time steps. However, recently, it has become important to also ensure the condition that each arm is exposed at least a certain fraction of time or a specified number of times (exposure equity/fairness condition) while maximizing the averaged total reward.

As machine learning algorithms advance, they are being introduced or discussed for use in various fields that closely affect our lives, such as loan approval, employment testing, sentencing, and fraud detection. As machine learning algorithms are introduced into various aspects of daily lives, they will have a significant impact on individual lives. This means that if a machine learning algorithm makes decisions that are biased toward a specific gender, social class, race, age, etc., it may have a negative impact on an individual's life. Considering these aspects, it is very important for the algorithm to make decisions fairly.

Contrary to expectations that machine learning algorithms will produce fair and neutral results, they may often produce biased results. For example, when conducting an employment test using a machine learning algorithm, if the algorithm makes a decision that is favorable to a specific gender, race, or age group, applicants of some gender, race, or age group who receive an unfavorable decision are disadvantaged compared to other applicants who receive favorable decisions, which leads to social inequality. In fact, as real-life examples of machine learning algorithms not making decisions fairly have been discovered, the need for fair algorithms is increasingly emphasized.

Why it is important for each arm to be exposed at least a certain fraction of time or a certain number of times will be described using an example of a recommendation system. However, the fair multi-arm bandit pursued in the present disclosure is not only applied to the recommender system, but can be applied to all applications that pursue fair exposure of each arm.

These fairness issues are also important in a recommender system, one of the fields of machine learning algorithms. The recommendation system is designed based on people's purchasing behavior patterns, but since there is a high probability of making a purchase from the items recommended by the recommendation system, the recommendation system also determines people's purchasing behavior patterns. In this way, the relationship between people's purchasing behavior patterns and recommended items may cause unfairness or bias to be further amplified and worsened when unfair or biased elements exist in the recommendation system.

Bias in recommender systems causes various problems depending on specific application cases. For example, job advertisements used on certain social networks have been reported to show bias based on gender and race. When job advertisements are biased, among the many people who use the certain SNS, people of genders and races that do not benefit from the algorithm's bias will inevitably be at a disadvantage when looking for a job. This causes social inequality. In addition, it has been reported that there is unfairness in a music recommendation system due to the artist's gender. As a result, the opportunity for music sources to be recommended to users is not given fairly, but is given unfairly based on the gender of the artist, which may lead to the problem of income imbalance in which music sources by artists of a certain gender are not consumed in large quantities. Also, in the case of the music market, highly recommended music sources account for a high portion of the music market's sales, while music sources that are not recommended often generate little income, resulting in a phenomenon where the rich get richer while the poor get poorer. If this phenomenon is exacerbated, it may lead to economic imbalance among artists. In addition, the recommended list of music sources may become monotonous, which may result in minority tastes being ignored. In the case of news articles, because recommended articles are viewed as biased by readers, readers' opinions/political tendencies may become biased or narrow-minded, and readers may also develop extreme tendencies.

Considering the various problems mentioned above, it is necessary to prevent bias in the recommendation system by giving fair exposure opportunities to various items. In other words, there is needed a recommendation system algorithm ensuring that recommended items are exposed to users for a certain period of time and have the opportunity to be selected by the user (ensuring fairness), while maximizing the rewards from the recommendation system. However, existing recommendation systems only aim to maximize rewards, so the existing recommendation systems do not provide opportunities for items to be fairly exposed to consumers/users.

### SUMMARY

Embodiments of the present disclosure provide a multi-armed bandit method and apparatus for selecting K items out of a total of M items (K<M), that maximizes the averaged total reward of a recommender system while ensuring exposure equity that each item is exposed to users every time step, for at least a certain fraction of each time step.

However, the objects to be achieved by the present disclosure are not limited to the above, and may be expanded in various environments without departing from the idea and scope of the present disclosure.

In accordance with one embodiment of the present disclosure, there is provided a multi-armed bandit (MAB) method for selecting multiple items while ensuring fairness of exposure of the multiple items and maximizing the averaged total reward, which is performed by a multi-armed bandit apparatus, wherein each item is referred to as an arm when there are multiple items, the method comprising: initializing the empirical mean reward and number of arm selections of each arm for the M arms, and the time step, wherein M is a total number of arms; incrementing the time step; calculating the upper confidence bound (UCB) index of each arm for the M arms, wherein the UCB index of each arm is calculated using its empirical mean reward and number of arm selections; selecting K−1 arms with the K−1 highest UCB indices calculated, wherein K is a value less than M; calculating unfairness indices for the unchosen M−(K−1) arms; checking if there is an arm with a positive unfairness index among the unchosen M−(K−1) arms; selecting the remaining single arm depending on whether there is an arm with a positive unfairness index among the unchosen M−(K−1) arms; playing the selected K arms; and updating the empirical mean reward and the number of arm selections for the played arms.

The K items are selected out of M items at each time step.

For each time step t (1≤t≤T) and each arm i (1≤i≤M), a fairness constraint n_{i,t}≥└cᵢ·t┘ is satisfied, where n_{i,t} represents the number of times arm i to be played up to time step t, and cᵢ represents the minimum fraction of times that arm i should be played at least └cᵢ·t┘ times at time step t.

In the calculating of the unfairness indices, when the unfairness index of arm i at time step t−1 for each arm i is defined as f_{i,t-1}, the unfairness index of arm i at time step t−1 is calculated according to the following equation,

$${f}_{i , t - 1} := {c}_{i} ( t - 1 ) - {n}_{i , t - 1} , ∀ i ∈ [ M ]$$

In the calculating of the UCB index, the UCB index of each arm for the M arms is calculated by applying any UCB index calculation method used in a single-play multi-armed bandit (MAB) algorithm.

In the calculating of the UCB index, when the UCB1 index of arm i is calculated according to the following equation, the averaged regret has an upper bound of O(1) (a constant upper bound).

$${u}_{i} ( t - 1 ) := {\hat{θ}}_{i , {n}_{i , t - 1}} + \sqrt{\frac{2 ln ( t - 1 )}{{n}_{i , t - 1}}}$$

In the calculating of the UCB index, when the KL-UCB index of arm i is calculated according to the following equation, the averaged regret has an upper bound of O(1) (a constant upper bound).

$${u}_{i} ( t - 1 ) := max \{ q > {\hat{θ}}_{i , {n}_{i , t - 1}} \vert {n}_{i , t - 1} d ( {\hat{θ}}_{i , {n}_{i , t - 1}} , q ) \leq ln ( t - 1 ) + a ln ( ln ( t - 1 ) ) \}$$

where, a is a real number of a≥0, and d(p, q) means the Kullbeck-Leibler divergence for p being a real number of 0≤p≤1 and q being a real number of 0≤q≤1, and is defined as

$$d ( p , q ) = p ln \frac{p}{q} + ( 1 - p ) ln ( \frac{1 - p}{1 - q} ) .$$

In the selecting of the remaining single arm, when there is an arm with a positive unfairness index among the unchosen M−(K−1) arms, the arm with the highest positive unfairness index among the unchosen M−(K−1) arms is selected.

In the selecting of the remaining single arm, when there is no arm with a positive unfairness index among the unchosen M−(K−1) arms, the arm with the highest UCB index among the unchosen M−(K−1) arms is selected.

In accordance with one embodiment of the present disclosure, there is provided a multi-armed bandit(MAB) apparatus for selecting multiple items while ensuring fairness of exposure of the multiple items and maximizing the averaged total reward, wherein each item is referred to as an arm when there are multiple items, the apparatus comprising: a memory storing one or more programs related to multi-armed bandit for selecting multiple items while ensuring fairness of exposure of items and maximizing the averaged total reward; and a processor that executes the one or more stored programs, wherein the processor is configured to: initialize the empirical mean reward and number of arm selections of each arm for the M arms, and the time step, wherein M is a total number of arms, increment the time step, calculate the upper confidence bound (UCB) index of each arm for the M arms, wherein the UCB index of each arm is calculated using its empirical mean reward and number of arm selections, select K−1 arms with the K−1 highest UCB indices calculated, wherein K is a value less than M, calculate unfairness indices for the unchosen M−(K−1) arms, check if there is an arm with a positive unfairness index among the unchosen M−(K−1) arms, select the remaining single arm depending on whether there is an arm with a positive unfairness index among the unchosen M−(K−1) arms, play the selected K arms, and update the empirical mean reward and the number of arm selections for the played arms.

The K items are selected out of M items at each time step.

For each time step t (1≤t≤T) and each arm i (1≤i≤M), a fairness constraint n_{i,t}≥└cᵢ·t┘ is satisfied, where n_{i,t} represents the number of times arm i to be played up to time step t, and cᵢ represents the minimum fraction of times that arm i should be played at least └cᵢ·t┘ times at time step t.

When the unfairness index of arm i at time step t−1 for each arm i is defined as f_{i,t-1}, the processor calculates the unfairness index of arm i at time step t−1 according to the following equation,

$${f}_{i , t - 1} := {c}_{i} ( t - 1 ) - {n}_{i , t - 1} , ∀ i ∈ [ M ]$$

The processor calculates the UCB index of each arm for the M arms by applying any UCB index calculation method used in a single-play multi-armed bandit (MAB) algorithm.

When the processor calculates the UCB1 index of arm i according to the following equation, the averaged regret has an upper bound of O(1) (a constant upper bound).

$${u}_{i} ( t - 1 ) := {\hat{θ}}_{i , {n}_{i , t - 1}} + \sqrt{\frac{2 ln ( t - 1 )}{{n}_{i , t - 1}}}$$

When the processor calculates the KL-UCB index of arm i according to the following equation, the averaged regret has an upper bound of O(1) (a constant upper bound).

$${u}_{i} ( t - 1 ) := max \{ q > {\hat{θ}}_{i , {n}_{i , t - 1}} \vert {n}_{i , t - 1} d ( {\hat{θ}}_{i , {n}_{i , t - 1}} , q ) \leq ln ( t - 1 ) + a ln ( ln ( t - 1 ) ) \}$$

where, a is a real number of a≥0, and d(p, q) means the Kullbeck-Leibler divergence for p being a real number of 0≤p≤1 and q being a real number of 0≤q≤1, and is defined as

$$d ( p , q ) = p ln \frac{p}{q} + ( 1 - p ) ln ( \frac{1 - p}{1 - q} ) .$$

When there is an arm with a positive unfairness index among the unchosen M−(K−1) arms, the processor selects the arm with the highest positive unfairness index among the unchosen M−(K−1) arms.

When there is no arm with a positive unfairness index among the unchosen M−(K−1) arms, the processor selects the arm with the highest UCB index among the unchosen M−(K−1) arms.

The technology of the present disclosure can have the following effects. However, since it does not mean that a specific embodiment should include all of the following effects or only the following effects, the scope of the present disclosure should not be understood as being limited thereby.

Embodiments of the present disclosure can select multiple recommended items that maximizes the averaged total reward of the recommendation system while ensuring exposure fairness that each item is exposed to users for a certain period of time.

Embodiments of the present disclosure can increase sales volume of small businesses without significantly affecting the profits of platform operators and large-scale operators by ensuring fairness while maximizing rewards for user selection.

Embodiments of the present disclosure can provide consumers with more diverse choices and can satisfy consumers' diverse tastes.

Embodiments of the present disclosure can increase the diversity of provided content, leading to an increase in consumer traffic, so that users, platform operators, large-scale operators, and small-scale operators can all benefit.

Embodiments of the present disclosure can create a fairer and more balanced market environment by preventing market monopolies by certain stores, companies, and publishers in the restaurant, music market, and book sales fields.

Embodiments of the present disclosure can increase sales revenue of small stores and businesses, thereby achieving the effect of income distribution.

Embodiments of the present disclosure can contribute not only to the development of a fair society, but also to a society that respects the diverse opinions and tastes of individuals.

Embodiments of the present disclosure can achieve the social effect of strengthening diversity and inclusiveness by preventing various tendencies, including political tendencies, from becoming intolerance.

### BRIEF DESCRIPTION OF THE DRAWINGS

FIG. 1 is a diagram showing pseudocode for a multi-armed bandit method for selecting multiple items while ensuring fairness of exposure of the multiple items and maximizing the averaged total reward according to one embodiment of the present disclosure.

FIG. 2 is a flowchart of the multi-armed bandit method for selecting multiple items while ensuring fairness of exposure of the multiple items and maximizing the averaged total reward according to one embodiment of the present disclosure.

FIG. 3 is a diagram showing the results of fairness constraint simulation.

FIG. 4 is a diagram showing a regret graph of the multi-armed bandit method according to one embodiment of the present disclosure.

FIG. 5 is a block diagram of a multi-armed bandit apparatus for selecting multiple items while ensuring fairness of exposure of the multiple items and maximizing the averaged total reward according to one embodiment of the present disclosure.

### DETAILED DESCRIPTION

The present disclosure can be modified in various ways and can have various embodiments, and specific embodiments will be illustrated in the drawings and described in detail in the detailed description. However, this is not intended to limit the present disclosure to specific embodiments, and may be understood to include all modifications, equivalents, and substitutes included in the technical idea and scope of the present disclosure. In describing the present disclosure, if it is determined that a detailed description of related known technologies may obscure the gist of the present disclosure, the detailed description will be omitted.

Terms such as first, second, etc. may be used to describe various components, but the components are not limited by the terms. The terms are used only to distinguish one component from another.

The terms used in the present disclosure are intended to describe particular embodiments only and are not intended to limit the present disclosure. The terms used in the present disclosure have been selected from general terms that are currently widely used as much as possible while considering the functions in the present disclosure, but they may vary according to the intention of a person skilled in the art, the precedents, the emergence of new technologies, and the like. In addition, in a specific case, there is also a term arbitrarily selected by the inventors, and in this case, its meaning will be described in detail in the description of the present specification. Accordingly, the terms used in the present disclosure should be defined based on the meanings of the terms and the whole contents of the present disclosure, not simply the names of the terms.

Singular expressions include plural expressions unless the context clearly indicates otherwise. In the present disclosure, terms such as “comprise or include” or “have” are intended to designate the presence of features, numbers, steps, operations, components, parts, or combinations thereof described in the specification, and should not be understood as precluding the possibility of the existence or addition of features, numbers, steps, operations, components, parts, or combinations thereof.

Hereinafter, embodiments of the present disclosure will be described in detail with reference to the accompanying drawings. In the description with reference to the accompanying drawings, identical or corresponding components will be assigned the same reference numerals and redundant description thereof will be omitted.

First, multi-armed bandit (MAB) problem will be described. The MAB problem is a type of sequential decision-making problem. When there are multiple selection items or multiple items, each selection item or each item is referred to as an arm. There exists multiple arms, and when each arm is played (or is chosen to play), a reward is generated for the played arm. The reward for each arm played is a random variable, and the reward is different each time the arm is played. While no information is given about the random variables of the rewards for each arm, the specific reward is known when an arm is played. In this situation, when the opportunity to play an arm is given T times, at each time step t (1≤t≤T), the problem is to find which arm to play at each time step t to maximize the averaged total reward for the total time based on past information (history: which arm was selected and rewards that occur when the selected arms are played) of selected arms and their rewards during the past time steps t−1. In other words, given a total of T time steps and a choice of arms to play at each time step t (1≤t≤T), the problem is to determine which arms to play at each time step based on past information to maximize the averaged total reward earned at all time steps.

The multi-armed bandit can be applied to recommendation systems, finding secondary channels in cognitive radio, routing, and finding medical methods/drugs suitable for patients.

Recommendation systems are one of the representative applications of MAB. Recommendation systems are the systems that recommend information, items, or services that people may be interested in. Hereinafter, items include products, drugs, advertisements, medical methods, channels and target addresses, etc.

To explain how MAB is applied to recommendation systems, a recommendation system that recommends products in e-commerce is used as an example.

Arm: Products sold on e-commerce websites. If there are M products for sale, there are M arms.

Playing an arm: Act of placing a product in a recommended list on an e-commerce website.

Reward: When a product is recommended to a user, if the user responds to the recommended product in various forms such as clicking, purchasing, or rating, the business operator aggregates this and quantifies it as a reward. For example, when a product is recommended to a user, if the user purchases the recommended product, revenue is generated for the business. The business operator can define the revenue generated from recommended products as a reward. Defining the reward as revenue is just one example, and the reward may be defined in various ways depending on the goal the business operator wants to maximize.

MAB Algorithm: Algorithm that determines the product to recommend for each time step with the goal of maximizing sales when recommending a product for each time step over T time steps when the user's preference or level of interest in product is not known.

In addition to the e-commerce example, MAB can be applied in a similar manner to that described above to various application cases that require a recommendation system.

The reward for each arm is a random variable, so even for the same arm, the reward may be different each time the arm is played. The mean value of the probability distribution for reward may be referred to as the mean reward (mean, average, expectation). If the probability distribution for reward for each arm is known in advance, the averaged total reward can be maximized by placing the arm with the highest mean value of the probability distribution for reward, i.e., the highest mean reward, on a recommendation list. However, since the probability distribution of the rewards of the arms is not known in advance, the mean rewards of the arms are also not known in advance. The reward of the arm can only be known when the arm is played. The reward generated by playing the arm is called sample reward, and the average of the sample rewards is called the empirical mean reward (or sample average).

In the MAB problem, since the probability distribution for the reward of each arm is not known in advance, performing “exploitation” and “exploration” in a balanced manner is commonly used as one of the effective strategies to solve the MAB problem. Exploitation means that when selecting an arm to play at a particular time step t, the empirical mean reward at time step t−1 is calculated for all arms using the sample rewards that occurred when the arms were played during the past time step t−1, and the arm with the highest empirical mean reward at time step t−1 is selected. However, if only the arms with the highest empirical reward average are selected, arms with large true mean rewards but low empirical mean rewards will not be selected, and suboptimal arms may continue to be selected.

For example, suppose arm 1 has a mean reward of 5, and arm 2 has a mean reward of 3. Suppose arm 1 was selected three times, and the sample rewards were 3, 4, and 2. On the other hand, in the case of arm 2, suppose arm 2 was selected 5 times, and the sample rewards were 5, 4, 3, 4, and 2. In this case, the empirical mean reward of arm 1 is (3+4+2)/3=3 and the empirical mean reward of arm 2 is (5+4+3+4+2)/5=3.6. Therefore, using the empirical mean reward for the two arms, continuing to select arm 2 can be considered a good decision because the empirical mean reward for arm 2 is 3.6, which is larger than the empirical mean reward of 3 for arm 1. However, in reality, because the mean reward of arm 1 is 5, which is greater than the mean reward of 3 for arm 2, continuing to select arm 2 does not maximize the reward. The reason why the empirical mean reward of arm 1 is less than the true mean reward is because the arm is not played a sufficient number of times, so there is a large difference between the true mean reward and the empirical mean reward. If both arm 1 and arm 2 are played a sufficient number of times, the difference between the empirical mean reward of each arm and the true mean reward becomes smaller according to the Law of Large Numbers (LLN), and the probability that the empirical mean reward of arm 1 will be greater than the empirical mean reward of arm 2 increases. Therefore, it is necessary to play enough arms even if the empirical mean reward is small. Exploration means selecting an arm other than the arm with the highest empirical mean reward to find out whether there is an arm with a large true mean reward even if the current empirical mean reward is small. In short, a general strategy for solving the MAB problem is to balance “exploration” to find an arm with the highest true mean reward among arms that do not have the highest empirical mean reward, and “exploitation” to select an arm with the highest empirical mean reward.

One of the approaches to effectively solve the MAB problem while balancing “exploitation” and “exploration” is to calculate a UCB (Upper Confidence Bound) index and select arms based on the UCB index. The UCB index is the upper-confidence-bound (UCB) of the mean reward. The UCB index is calculated using the empirical mean reward and the number of times the arm is played, and generally has a value greater than the empirical mean reward. The UCB index can be calculated in various ways.

The single-play MAB algorithm recommends one item, and the multiple-play MAB or combinatorial MAB algorithm recommends multiple items.

The performance of MAB is measured by its regret. If the mean rewards of all arms are known, selecting the arm that maximizes the averaged total reward is to select the arm with the highest mean reward at each time step. The regret is defined as the difference between the average value of the total reward that occurs when the arms with the highest mean reward are selected each time at all time steps and the average value of the total reward that actually occurs when the MAB algorithm is executed. The smaller the regret, the better the performance of the MAB algorithm. In many existing MAB algorithms, when T approaches infinity, the regret has an upper bound of O(ln T).

Embodiments of the present disclosure relate to a fair multi-armed bandit method and apparatus for selecting multiple items that guarantee the exposure fraction of the items and maximizing the averaged total reward. Before describing in detail the MAB problem to be solved by embodiments of the present disclosure, to avoid confusion regarding terminology to be used herein, it is noted that the following terms may be used. “i-th arm” and “arm i” may be used interchangeably. “Exposure of items,” “playing arms,” and “selecting arms” may be used interchangeably. When applying the embodiments of the present disclosure to a recommender system, selecting and playing an arm in the embodiments of the present disclosure is the same as selecting an item to recommend and then exposing it to the user in the recommender system.

The problem to be solved by the embodiments of the present disclosure relates to a multiple-play MAB that selects exactly K arms out of a total of M arms at each time step for a total time T, where K arms to be played are determined at each time step in order to maximize the averaged total reward received over a given time T of time while ensuring that each arm satisfies a predetermined exposure equity requirement. In this case, K is a value less than M.

The exposure equity requirement to ensure the fraction for each arm, that is, the fairness constraint, is for the minimum number of times that at least a certain fraction of cᵢ should be selected every time t. The fairness constraint is defined as a real number cᵢ greater than 0 and less than 1, which specifies the minimum fraction of time that the arm i should be exposed to. More specifically, if the total number of times arm i is selected after arms are selected from time step 1 to time step t according to the embodiments of the present disclosure is denoted as n_{i,t}, the fairness constraint for arm i is defined as an inequality n_{i,t}≥└cᵢ·t┘. └x┘ represents the largest integer among integers less than or equal to x. This inequality means that arm i should be included in the recommendation list and exposed to users at time steps that correspond to at least a proportion cᵢ of t time steps. These fairness constraints should be satisfied for all time steps t and all arms i.

In order to solve the MAB problem as defined above, embodiments of the present disclosure may select multiple items while ensuring fairness of exposure of the multiple items and maximizing the averaged total reward. The embodiments of the present disclosure select exactly K arms at each time step using the UCB index and unfairness index. The UCB index uᵢ (t) at time t is a value greater than the empirical mean reward and may be defined in various ways for each algorithm. The unfairness index is a value that measures the unfairness of arm, and the unfairness index fᵢ(t) for arm i at time step t is defined as cᵢ·t−n_{i,t}.

The advantages of the embodiments of the present disclosure are as follows.

The embodiments of the present disclosure select a fixed number (e.g. K) of arms for each time step.

The embodiments of the present disclosure are easy to implement because arms are selected using only the UCB index and the unfairness index.

The embodiments of the present disclosure can easily extend any existing single-play MAB algorithm using the UCB index to a multi-play MAB algorithm.

When arms are selected in case of

$$0 \leq {c}_{i} < \frac{1}{M - K + 1}$$

for all i, the fairness constraint n_{i,t}≥└cᵢ·t┘ is always satisfied for all time steps t and all arms i according to the embodiments of the present disclosure. Upon calculating the UCB index, when extending the existing single-play MAB algorithm using the UCB index, including UCB1, KL-UCB, etc., to a multi-play MAB algorithm, if 0

$$\leq {c}_{i} < \frac{1}{M - K + 1}$$

for all i is satisfied, the fairness constraint n_{i,t}≥└cᵢ·t┘ is always satisfied at every time step t and at every arm i. This was proven mathematically and verified experimentally.

In the embodiments of the present disclosure, performance is guaranteed when using the UCB index used in the commonly used UCB1 and KL-UCB algorithms. It has been proven mathematically and verified experimentally that in case of 0

$$\leq {c}_{i} < \frac{1}{M - K + 1}$$

for all i, the regret (fairness-aware regret) of the embodiments of the present disclosure that uses the UCB index used in the UCB1 algorithm as the UCB index has an upper bound of O(1) when T is sufficiently large, that is, the regret (fairness-aware regret) is less than a certain constant. It has been proven mathematically and verified experimentally that in case of 0

$$\leq {c}_{i} < \frac{1}{M - K + 1}$$

for all i, the regret (fairness-aware regret) of the embodiments of the present disclosure that uses the UCB index used in the KL-UCB algorithm as the UCB index has an upper bound of O(1) when T is sufficiently large.

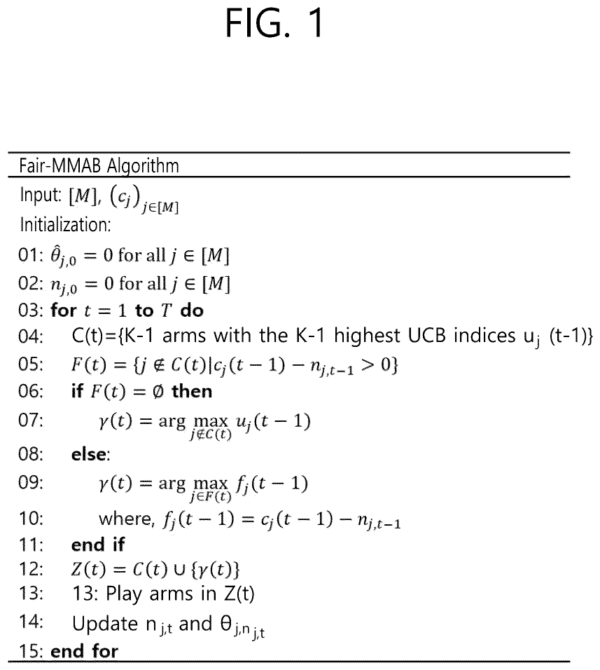

FIG. 1 is a diagram showing pseudocode for a multi-armed bandit method for selecting multiple items while ensuring fairness of exposure of the multiple items and maximizing the averaged total reward according to one embodiment of the present disclosure.

The pseudocode according to one embodiment of the present disclosure is shown in FIG. 1, and the operating principle of one embodiment of the present disclosure is as follows.

When selecting an arm at each time step, a multi-arm bandit apparatus according to one embodiment of the present disclosure first calculates the UCB indices for all M arms. Any UCB index that is used in a single-play MAB algorithm can be used. When the single-play MAB algorithm is predefined UCB1 or KL-UCB, the UCB indices will be described in detail later. The multi-armed bandit apparatus selects K−1 arms with the K−1 highest UCB indices uⱼ(t−1) of the immediately preceding time step t−1. The set of arms selected in this way is called C(t). In order to select the remaining single arm, called γ(t), the multi-armed bandit apparatus calculates the unfairness index value fⱼ (t−1) of the immediately preceding time step t−1 for the arms that do not belong to C(t). If there are arm(s) with a positive unfairness index fⱼ(t−1) among the arms that do not belong to C(t), the multi-arm bandit apparatus additionally selects the single arm with the highest unfairness index as the remaining single arm γ(t). If there is no arm with the positive unfairness index fⱼ(t−1) among the arms that do not belong to C(t), the multi-arm bandit apparatus additionally selects the single arm with the highest UCB index among the arms that do not belong to C(t) as the remaining single arm γ(t). The multi-armed bandit apparatus plays the arms included in Z(t) using the equation Z(t)=C(t) U {γ(t)}. And, the multi-armed bandit apparatus obtains sample rewards generated by playing the arms. Then, the multi-armed bandit apparatus updates the number of arm selections n_{j,t} and the empirical mean reward \hat{θ}_{j,n}_{_{j,t}} for each of the played arms, i.e., for each arm j (j E Z(t)). In this case, \hat{θ}_{j,n}_{_{j,t}} represents the empirical mean reward of arm j calculated from sample rewards that occurred during the time step t. The number of arm selections is updated by the equation n_{j,t}=n_{j,t-1}+1, and the empirical mean reward is updated by the equation

$${\hat{θ}}_{j , {n}_{j , t}} = \frac{1}{{n}_{j , t}} {\sum }_{k = 1}^{{n}_{j , t}} {X}_{j , k} .$$

For arms j (j∉Z(t)), n_{j,t}=n_{j,t-1}+1 is applied.

Specific details about the multi-armed bandit apparatus will be described by way of example. Embodiments of the present disclosure relate to a multi-armed bandit method for selecting a plurality of items or multiple items while ensuring a certain fraction of the items. The specific definition of the MAB problem to be solved by the embodiments of the present disclosure is as follows.

MAB problem involves selecting K arms from a total of M arms at each time step t over the total time T.

All arms should satisfy the predetermined exposure equity requirements for each time step t.

The goal is to maximize the averaged total reward received when selecting arms during a given time T.

The variables and symbols used herein, to describe in detail the MAB problem to be solved and the designed algorithm, are summarized as follows.

i: arm i

[M]={1, 2, . . . , M}: a set of all arms.

n_{i,t}: the number of times arm i selected from time step 1 to time step t.

X_{i,k}: sample reward that occurs when the arm i is selected k times after the selected arms are played in the time step t. It is assumed that X_{i,k}'s are independently and identically distributed for each i. It is further assumed that X_{i,k} and X_{j,l} are independent for any i≠j or k≠l.

θᵢ: mean reward of arm i.

θ=(θ₁, . . . , θᵢ, . . . , θ_{M}): an ordered list of the mean reward for each arm for M arms. It is assumed that 1≥θ₁>θ₂> . . . >θ_{M}>0 is satisfied without loss of generality. The value θ cannot be known in advance by the MAB algorithm. \hat{θ}_{i,n}_{_{i,t}}: empirical mean reward calculated using the sample rewards of arm i obtained from time step 1 to time step t. It is calculated as

$${\hat{θ}}_{i , {n}_{i , t}} = \frac{1}{{n}_{i , t}} {\sum }_{k = 1}^{{n}_{i , t}} {X}_{i , k} .$$

cᵢ: a real number greater than 0 and less than 1 that represents the fraction of time that arm i should be exposed to at least in the fairness constraints for arm i. It is used when setting a fairness constraint n_{i,t}≥└cᵢ·t┘ for each arm. └cᵢ·t┘ represents the largest integer among integers less than or equal to cᵢ·t.

c=(c₁, . . . , c_{M}): a sequential list of cᵢ for each arm, for the M arms.

a=(a₁, a₂, . . . , a_{K}): K arms are selected at each time step, and the sequential list of arms played is called a super-arm and is denoted as a. They are sorted in ascending order. For example, when K=3 and t=2, if the arms selected at time step 2 are arm 1, arm 3, and arm 4, the selected super-arm is a=(1,3,4).

[symbol] ={(a₁, a₂, . . . , a_{K})|1≤a₁<a₂< . . . <a_{K}≤M}: a set of all super-arms that can be composed of K arms.

m_{a,t}: the total number of times super-arm a selected from time step 1 to time step t after the arms are selected at each time step.

[symbol] ₖ: a subset formed by gathering only the super-arms including arm k among the super-arms included in [symbol] .

The MAB problem to be solved by the embodiments of the present disclosure is described as the following optimization problem using the variables and symbols defined above.

$$Maximize {\sum }_{a ∈ 𝒥} {m}_{a , t} ( {θ}_{{a}_{1}} + … + {θ}_{{a}_{K}} ) \qquad ( Equation 1 )$$

$$s . t . {\sum }_{a ∈ {𝒥}_{k}} {m}_{a , t} \geq ⌊ {c}_{k} t ⌋ \qquad ( Equation 2 )$$

$$0 \leq {m}_{a , t} \leq t \qquad ( Equation 3 )$$

$${\sum }_{a ∈ 𝒥} {m}_{a , t} = t \qquad ( Equation 4 )$$

The optimization problem has been derived by analyzing the MAB problem to be solved by the embodiments of the present disclosure from the perspective of super-arm. Selecting K arms at every time step for a total time T is equivalent to selecting one super-arm composed of K arms at every time step. Equation 1, which corresponds to the objective function of the optimization problem, means the averaged total reward generated by selecting t super-arms during time steps 1, . . . , t. And, the goal is to maximize the averaged total reward for each time t. The constraints of the above optimization problem are Equations 2 to 4, which are three in total. The first constraint shown in Equation 2 corresponds to the fairness constraint. The total sum of the number of times super-arms containing arm k were selected during each time t, [symbol] m_{a,T}, is equal to the number of times arm k was selected, n_{k,t}, which should be greater than or equal to └cₖt┘ by the fairness constraint. Here, n_{k,t} represents the number of times arm k was selected in time step t. The second constraint shown in Equation 3 is a condition related to the number of selections of super-arms, which means that the number of selections of each super-arm cannot exceed t times. The third constraint shown in Equation 4 is also a condition related to the number of selections of the super-arm, which means that since the super-arms are selected a total of t times during t time steps, the sum of the number of selections for all super-arms should be t.

If the optimal solution of the above optimization problem Equations 1 to 4 is denoted as m_{a,t}*, the optimal solution m_{a,t}* is as follows, when

$$0 \leq {c}_{i} < \frac{1}{M - K + 1}$$

for all i.

$${m}_{a , T}^{*} \{ \begin{matrix}T - {\sum }_{t = K + 1}^{M} ⌊ {c}_{l} T ⌋ , & if a = ( 1 , 2 , ⋯ , K - 1 , K ) \\ ⌊ {c}_{l} T ⌋ , & if a = ( 1 , 2 , ⋯ , K - 1 , l ) \\ 0 , & otherwise\end{matrix} \qquad ( Equation 5 )$$

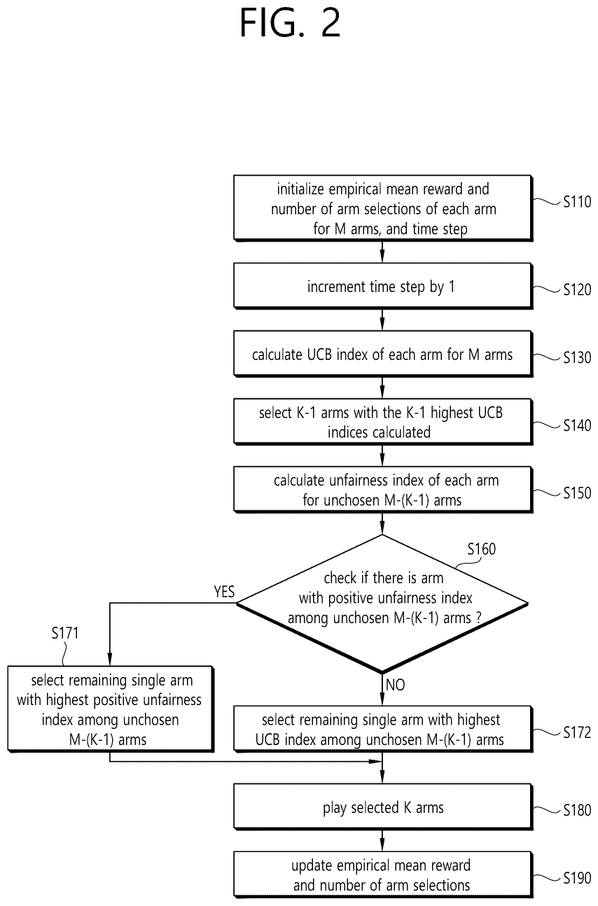

Based on the above optimal solution, the multi-armed bandit apparatus according to the embodiments of the present disclosure can perform the multi-armed bandit method. The specific steps of the multi-armed bandit method are explained using the flow chart shown in FIG. 2. The multi-armed bandit method includes the following steps.

FIG. 2 is a flowchart of the multi-armed bandit method for selecting multiple items while ensuring fairness of exposure of the multiple items and maximizing the averaged total reward according to one embodiment of the present disclosure.

The multi-armed bandit apparatus initializes the empirical mean reward and the number of arm selections of each arm for all arms (i.e. M arms), and the time step (S110). In this case, the multi-armed bandit apparatus may initialize the average experience reward for all arms (i.e. M arms) and the number of arm selections to 0 for all arms (i.e. M arms), and initialize the time step to 0.

$$\begin{matrix}{\hat{θ}}_{i , 0} := 0 , ∀ i ∈ [ M ] \\ {n}_{i , 0} := 0 , ∀ i ∈ [ M ] \\ t := 0\end{matrix} \qquad ( Equation 6 )$$

The multi-armed bandit apparatus increments the time step by 1 (S120). In this case, the multi-armed bandit apparatus may increment the time step by 1 as follows.

$$t := t + 1 \qquad ( Equation 7 )$$

The multi-armed bandit apparatus calculates the UCB index of each arm for the M arms (S130). In this case, the multi-arm bandit apparatus calculates the UCB index for all arms (i.e. M arms). A single-play MAB algorithm using the UCB index including UCB1 and KL-UCB may be applied. For the UCB1 and KL-UCB algorithms, the UCB index is as follows.

$$UCB 1 : {u}_{i} ( t - 1 ) := {\hat{θ}}_{i , {n}_{i , t - 1}} + \sqrt{\frac{2 ln ( t - 1 )}{{n}_{i , t - 1}}} \qquad ( Equation 8 )$$

$$KL - UCB : {u}_{i} ( t - 1 ) := max \{ q > {\hat{θ}}_{i , {n}_{i , t - 1}} \vert {n}_{i , t - 1} d ( {\hat{θ}}_{i , {n}_{i , t - 1}} , q ) \leq ln ( t - 1 ) + a ln ( ln ( t - 1 ) ) \} \qquad ( Equation 9 )$$

where, a is a real number of a≥0, and d(p, q) means the Kullbeck-Leibler divergence for p being a real number of 0≤p≤1 and q being a real number of 0≤q≤1, and is defined as

$$d ( p , q ) = p ln \frac{p}{q} + ( 1 - p ) ln ( \frac{1 - p}{1 - q} ) .$$

The multi-armed bandit apparatus selects K−1 arms with the K−1 highest UCB indices calculated (S140). The multi-armed bandit apparatus may select (or choose) K−1 arms with the K−1 highest values among the UCB indices calculated in step S130 as follows. Namely, the multi-armed bandit apparatus may select K−1 arms with the first, the second, . . . , and (K−1)th highest values among the UCB indices calculated in step S130.

$$C ( t ) := \{ K - 1 arms with the K - 1 highest {u}_{i} ( t - 1 ) values \} \qquad ( Equation 10 )$$

The multi-armed bandit apparatus calculates the unfairness index for each of unchosen M−(K−1) arms (S150). In this case, the multi-armed bandit apparatus may calculate the unfairness index for each of the unselected (or unchosen) M−(K−1) arms as follows.

$${f}_{i , t - 1} := {c}_{i} ( t - 1 ) - {n}_{i , t - 1} , ∀ i ∈ [ M ] \qquad ( Equation 11 )$$

The multi-arm bandit apparatus checks if there is an arm with a positive unfairness index calculated in step S150 among the unchosen M−(K−1) arms as follows (S160).

$$F ( t ) := \{ i ∉ C ( t ) \vert {f}_{i , t - 1} > 0 \} \qquad ( Equation 12 )$$

The multi-armed bandit apparatus proceeds to step S171 if there is an arm with a positive unfairness index among the unchosen M−(K−1) arms, that is, F(t)≠Ø.

The multi-armed bandit apparatus proceeds to step S172 if there is no arm with a positive unfairness index among the unchosen M−(K−1) arms, that is, F(t)=Ø.

The multi-armed bandit apparatus selects (or chooses) the remaining single arm, γ(t), using the highest positive unfairness index, if there is an arm with a positive unfairness index among the unchosen M−(K−1) arms (S171). In this case, the multi-armed bandit apparatus may additionally select single arm with the highest positive unfairness index calculated in step S150 among the unchosen M−(K−1) arms as follows.

$$γ ( t ) := arg {max}_{i ∉ F ( t )} {f}_{i} ( t - 1 ) \qquad ( Equation 13 )$$

The multi-arm bandit apparatus selects the remaining single arm, γ(t), using the highest UCB index, if there is no arm with a positive unfairness index among the unchosen M−(K−1) arms (S172). In this case, the multi-armed bandit apparatus may additionally select single arm with the highest UCB index calculated in step S130 among the unchosen M−(K−1) arms as follows.

$$γ ( t ) := arg {max}_{i ∉ C ( t )} {u}_{i} ( t - 1 ) \qquad ( Equation 14 )$$

The multi-armed bandit apparatus plays the selected K arms (S180). In this case, a total of K arms selected as recommended items in the multi-armed bandit apparatus is the union of K−1 arms C(t) selected in step S140 and single arm γ(t) selected in step S171 or step S172. In Z(t):=C(t) ∪{γ(t)}, the arms included in Z(t) can be played.

The multi-armed bandit apparatus updates the empirical mean reward and the number of arm selections for each arm of the selected K arms (S190). In this case, the multi-armed bandit apparatus may update the empirical mean reward and the number of arm selections as follows.

$$\begin{matrix}{n}_{i , t} := \{ \begin{matrix}{n}_{i , t - 1} + 1 for i ∈ Z ( t ) \\ {n}_{i , t - 1} for i ∉ Z ( t )\end{matrix} , \\ {θ}_{i , {n}_{i , t}} := \frac{{\sum }_{s = 1}^{{n}_{i , t}} {X}_{i , s}}{{n}_{i , t}} , ∀ i ∈ Z ( t )\end{matrix} \qquad ( Equation 15 )$$

After this step, the multi-armed bandit apparatus proceeds to step S120 and starts recommending items at the next time step.

In this case, the FAIR-MMAB algorithm using the UCB index used in the UCB1 algorithm may be referred to as FAIR-MMAB-UCB1. The FAIR-MMAB algorithm using the UCB index used in the KL-UCB algorithm may be referred to as FAIR-MMAB-KL-UCB.

Meanwhile, the uniqueness of the embodiments of the present disclosure is as follows.

FAIR-MMAB can select multiple a fixed number of arms at each time step.

FAIR-MMAB is easy to implement because it selects arms using only the UCB index and the unfairness index.

FAIR-MMAB can be implemented by extending any existing single-play MAB algorithm using the UCB index to a multiple-play MAB algorithm.

When arms are selected using FAIR-MMAB, the fairness constraint n_{i,t}≥└cᵢ·t┘ is always satisfied for each time step t and each arm i. The fairness constraints are always satisfied for each time step t and each arm i, when we use any UCB index used in an existing UCB-based single multi-armed bandit algorithm.

The performance of FAIR-MMAB-UCB1 and FAIR-MMAB-KL-UCB is guaranteed. It has been mathematically proven that the regret (fairness-aware regret) R_{c}(T) of the FAIR-MMAB-UCB1 algorithm (see Equation 16) has an upper bound of O(1) when T is sufficiently large, that is, the regret (fairness-aware regret) is smaller than a certain constant. In this case, if T is greater than Tₒ, the regret has an upper bound of O(1). Tₒ can be obtained as follows. Let ε be a positive real number smaller than

$$\frac{{θ}_{K} - {θ}_{K - 1}}{2} , and {c}_{min} = {min}_{1 \leq i \leq M} {c}_{i} . Since {lim}_{t \to ∞} \frac{ln t}{t} = 0 ,$$

there exists a positive integer

$${T}_{o} \geq \frac{2}{{c}_{min}} such that \frac{ln t}{t} \leq \frac{{c}_{min} {ε}^{2}}{32} for any t \geq {T}_{o} .$$

Choose such Tₒ.

It has been mathematically proven that the regret (fairness-aware regret) of the FAIR-MMAB-KL-UCB algorithm has an upper bound of O(1) when T is sufficiently large. If T is greater than Tₒ, the regret has the upper bound of O(1). Tₒ can be obtained as follows.

$$Let {ε}_{1} = {min}_{i < j} \frac{{θ}_{i} - {θ}_{j}}{4} ,$$

and ε₀ be a positive real number smaller than

$${min}_{i < j} d ( {θ}_{j} + {ε}_{1} , {θ}_{i} - {ε}_{1} ) , and {c}_{min} = {min}_{1 \leq i \leq M} {c}_{i} .$$

### Since

$${lim}_{t \to ∞} \frac{ln ( t {ln}^{2} t )}{t} = 0 ,$$

there exists

$${T}_{o} \geq \frac{2}{{c}_{min}}$$

such that

$$\frac{ln ( t {ln}^{2} t )}{t} < \frac{{ε}_{0}}{4}$$

for any t>Tₒ. Choose such Tₒ.

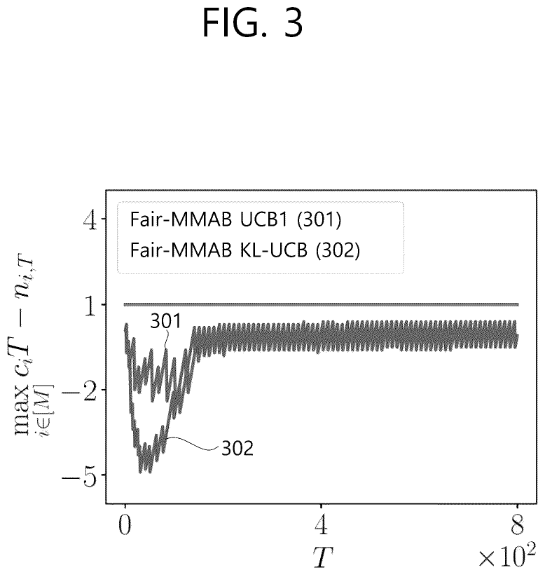

FIG. 3 is a diagram showing the results of fairness constraint simulation.

In order to prove the uniqueness of the embodiments of the present disclosure, in addition to mathematical proof, experimental verification based on simulation was also conducted. The conditions used in the simulation are as follows.
M=8, K=3
cᵢ=0.10, ∀i ∈[M]
θ=(0.9, 0.8,0.7,0.6,0.5,0.4,0.3,0.2)
For all arms i, the probability distribution of arm reward is set to Bernoulli distribution with θᵢ as the mean.
T=10₅
Simulate FAIR-MMAB-UCB1 and FAIR-MMAB-KL-UCB

First, to show that the fairness constraints are satisfied in all time steps and all arms, FAIR-MMAB-UCB1 and FAIR-MMAB-KL-UCB are simulated under the simulation conditions described above, and then based on the simulation results, it is checked whether

$${max}_{i ∈ [ M ]} {c}_{i} t - {n}_{i , t}$$

is less than 1. (If cᵢt−n_{i,t}<1 is true for all i (1≤i≤M), └cᵢt┘−n_{i,t}≤0 is true for all i. Therefore, if

$${max}_{i ∈ [ M ]} {c}_{i} t - {n}_{i , t} < 1$$

is satisfied, all arms satisfy the fairness condition └cᵢt┘≤n_{i,t}.)

Referring to FIG. 3, it can be seen that

$${max}_{i ∈ [ M ]} {c}_{i} t - {n}_{i , t}$$

values in both algorithms are less than 1 for each time step t when FAIR-MMAB-UCB1 (301) is used and FAIR-MMAB-KL-UCB (302) is used. This means that the fairness constraints are satisfied at every time step t for all arms when using FAIR-MMAB-UCB1 and FAIR-MMAB-KL-UCB.

In addition, regrets were calculated and analyzed to show that the performance of FAIR-MMAB-UCB1 and FAIR-MMAB-KL-UCB is guaranteed. The regret that measures the performance of MAB when there is the fairness constraint is defined differently from the regret of MAB that maximizes the averaged total reward without the fairness constraint. The maximum total reward of MAB without the fairness constraint occurs when selecting the optimal arms at every time step. However, if the maximum reward of MAB with the fairness constraint is defined as W*, W* occurs when selecting super-arm a as it is the optimal solution m_{a,T}* of Equations 1 to 4. Therefore, the regret [symbol] _{c}(T) in the case where there is the fairness constraint is the difference between W* and the averaged total reward that occurs when selecting the K arm at every time step according to MAB algorithm. In order to distinguish this regret [symbol] _{c} (T) from the regret of the MAB algorithm in the case where there are no existing fairness constraints, it is called fairness-aware regret. Fairness-aware regret, [symbol] _{c}(T), is calculated as follows.

$${ℛ}_{c} ( T ) = {W}^{*} - {\sum }_{i = 1}^{K} E [ {n}_{i , T} ] {θ}_{i} \qquad ( Equation 16 )$$

If super-arm (1,2, . . . , K) is denoted as a_{K}*, and for l(K+1≤l≤M), super-arm (1,2, . . . , K−1, l) is denoted as a_{K-1,l}*, W* is calculated as follows.

$$\begin{matrix}W = {m}_{{a}_{K}^{*} , . T}^{*} {\sum }_{i = 1}^{K} {θ}_{i} + {\sum }_{l = K + 1}^{M} {m}_{{a}_{K - 1 , l}^{*} , T}^{*} ( {\sum }_{l = 1}^{K - 1} {θ}_{i} + {θ}_{l} ) \\ = T {\sum }_{i = 1}^{K - 1} {θ}_{i} + ( T - {\sum }_{l = K + 1}^{M} ⌊ {c}_{l} T ⌋ ) {θ}_{K} + {\sum }_{l = K + 1}^{M} ⌊ {c}_{l} T ⌋ {θ}_{l}\end{matrix} \qquad ( Equation 17 )$$

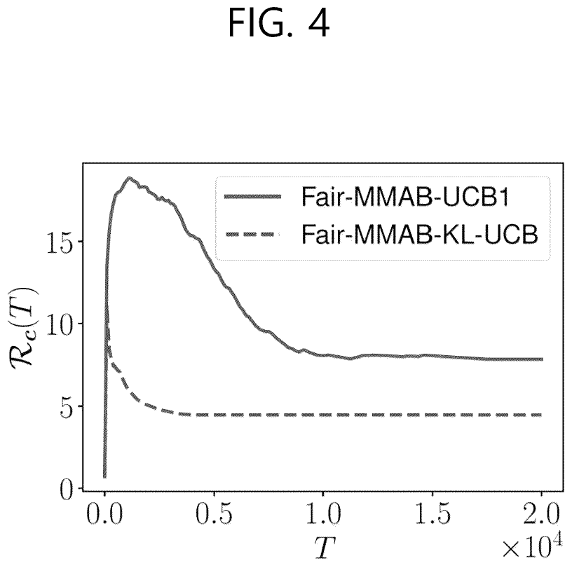

FIG. 4 is a diagram showing a regret graph of the multi-armed bandit method according to one embodiment of the present disclosure.

FIG. 4 is a graph showing the regret [symbol] _{c}(T) as a function of T for FAIR-MMAB-UCB1 and FAIR-MMAB-KL-UCB. Referring to the regret graphs of FAIR-MMAB-UCB1 and FAIR-MMAB-KL-UCB, it can be seen that the regrets converge over time. This means that for sufficiently large T, the upper bound of the regrets of FAIR-MMAB-UCB1 and FAIR-MMAB-KL-UCB is a constant, which is consistent with the results of the mathematical proof.

Meanwhile, an operation example of the multi-armed bandit method according to embodiments of the present disclosure will be described.

To describe embodiments of the present disclosure, symbols are defined as follows.

TABLE 1

| Symbol | Description | Symbol | Description |
|---|---|---|---|
| M | Total number of arms | K | Number of arms |
| | | | selected at each time |
| | | | step\| |
| cᵢ | Fairness constraint for | T | Total time (total |
| | arm i: value to indicate that | | number of time |
| | arm i should be selected at | | steps) |
| | least [cᵢ · t] times | | |
| | during time step t | | |
| n_{i, t} | Number of times arm i was | \hat{θ}_{i, n}_{_{i, t}} | Empirical mean reward |
| | selected at time step t | | of arm i calculated |
| | | | from sample rewards that |
| | | | occurred during time step |
| | | | t |
| uᵢ(t − 1) | UCB index of arm i | C(t) | Set of K − 1 arms with |
| | calculatedcalculated before | | the highest uᵢ (t − 1) |
| | selecting arm at time step t | | at time step t |
| fᵢ(t − 1) | Unfairness index of arm i, | F(t) | Set of arms where |
| | calculated before selecting | | fᵢ(t − 1) is positive |
| | arm at time step t. | | |
| y(t) | Single arm additionally | X_{i, k} | Sample reward generated |
| | selected according to F(t) | | when arm i is selected k |
| | at time step t | | times |
| Z(t) | Set of arms selected at time | | |
| | step t | | |

A problem to be solved by embodiments of the present disclosure is defined.

TABLE 2

| | | |
|---|---|---|
| M = 3 | K = 2 | cⁱ = 0.4, ∀i ∈ [1, 2, 3] |

Over a total of 9 time steps, select 2 out of 3 arms at each time step.
For each time step t, the number of times arm i is selected should be
greater than or equal to └0.4 · t┘
Implement FAIR-MMAB using UCB index used in UCB1 algorithm.

First, the number of arm selections and the empirical mean reward at time step t=0 are initialized as follows.

TABLE 3

| | Arm 1 | Arm 2 | Arm 3 |
|---|---|---|---|
| ni, 0 | 0 | 0 | 0 |
| \hat{θ}_{i, n}_{_{i, t}} | 0 | 0 | 0 |

First, an operation example of the multi-armed bandit method in time step t=1 will be explained.

0. The average number of arm selections and empirical rewards in the previous time step t=0 are as follows.

TABLE 4

| | Arm 1 | Arm 2 | Arm 3 |
|---|---|---|---|
| n_{i, 0} | 0 | 0 | 0 |
| \hat{θ}_{i, n}_{_{i, t}} | 0 | 0 | 0 |

1. The UCB index is calculated as follows (UCB index used in the UCB1 algorithm).

TABLE 5
${u}_{i} ( t - 1 ) := {\hat{θ}}_{i , {n}_{i , t - 1}} + \sqrt{\frac{2 ln ( t - 1 )}{{n}_{i , t - 1}}}$

| | Arm 1 | Arm 2 | Arm 3 |
|---|---|---|---|
| uᵢ(0) | 0 | 0 | 0 |

2. The multi-armed bandit apparatus selects K−1 arms, C(t), according to the UCB index.

TABLE 6

| | Arm 1 | Arm 2 | Arm 3 |
|---|---|---|---|
| uᵢ(0) | 0 | 0 | 0 |

| | |
|---|---|
| C(1) | The arm with the highest UCB index should be selected, but |
| | since the UCB indices of all arms is 0, Arm 1 is arbitrarily |
| | selected among Arm 1, Arm 2, and Arm 3. |

3. The multi-armed bandit apparatus calculates the unfairness index as follows.

TABLE 7
fᵢ(t − 1): = cᵢ · (t − 1) − n_{i, t-1}

| | Arm 1 | Arm 2 | Arm 3 |
|---|---|---|---|
| fᵢ(0) | 0 | 0 | 0 |

4. The multi-armed bandit apparatus selects the remaining single arm, γ(t), as follows.
F(1)=Ø?

Among the arms not in C(1), the arm with the highest UCB index should be selected, but since all of the arms have UCB indices of 0, arm 2 is arbitrarily selected among arms 2 and 3.
5. The multi-armed bandit apparatus collects K arms to be played as follows.
Z(t):=C(t)∪{γ(t)}
Z(1) Arm 1, Arm 2
6. The multi-armed bandit apparatus plays the selected arms as follows:

TABLE 8

| | |
|---|---|
| Z(1) | Arm 1, Arm 2 |

Play selected arms
↓ ↓
Sample rewards are generated

| | |
|---|---|
| Arm | Sample Reward (X_{i, n}_{_{i, t}}) |
| Arm 1 | 1 |
| Arm 2 | 1 |

7. The multi-armed bandit apparatus updates the number of arm selections and the empirical mean reward as follows.

$$- {n}_{i , t} := \{ \begin{matrix}{n}_{i , t - 1} + 1 for i ∈ Z ( t ) \\ {n}_{i , t - 1} for i ∉ Z ( t )\end{matrix} ,$$

$$- {\hat{θ}}_{i , {n}_{i , t}} := \frac{{\sum }_{s = 1}^{{n}_{i , t}} {X}_{i , s}}{{n}_{i , t}} , ∀ i ∈ Z ( t )$$

TABLE 9

| | Arm 1 | Arm 2 | Arm 3 | | | Arm 1 | Arm 2 | Arm 3 |
|---|---|---|---|---|---|---|---|---|
| {X_{i, k}}ₖ₌₁ⁿ^{_{i, 0}} | { } | { } | { } | Update | {X_{i, k}}ₖ₌₁ⁿ^{_{i, 1}} | {1} | {1} | { } |
| n_{i, 0} | 0 | 0 | 0 | → | n_{i, 1} | 1 | 1 | 0 |
| \hat{θ}_{i, n}_{_{i, 0}} | 0 | 0 | 0 | | \hat{θ}_{i, n}_{_{i, 1}} | 1.0 | 1.0 | 0 |

8. Fairness constraints are verified.

n_{i,t}≥└cᵢ·t┘ is verified to be true for t=2 as follows.

TABLE 10

| | | Arm 1 | Arm 2 | Arm 3 |
|---|---|---|---|---|
| Number or arm | n_{i, 1} | 1 | 1 | 0 |
| selections → | | | | |
| Minimum number of | [cᵢ · 1] | 0 | 0 | 0 |
| times arm should be → | | | | |
| selected to meet | | | | |
| fairness constraint | | | | |

Next, an operation example of the multi-armed bandit method in time step t=2 will be explained.
0. The average number of arm selections and empirical rewards in the previous time step t=1 are as follows.

TABLE 11

| | Arm 1 | Arm 2 | Arm 3 |
|---|---|---|---|
| n_{i, 1} | 1 | 1 | 0 |
| \hat{θ}_{i, n}_{_{i, t}} | 1.0 | 1.0 | 0 |

1. The UCB index is calculated as follows (UCB index used in the UCB1 algorithm).

$$- {u}_{i} ( t - 1 ) := {\hat{θ}}_{i , {n}_{i , t - 1}} + \sqrt{\frac{2 ln ( t - 1 )}{{n}_{i , t - 1}}}$$

TABLE 12

| | Arm 1 | Arm 2 | Arm 3 |
|---|---|---|---|
| uᵢ(1) | 1.0 | 1.0 | 0 |

2. The multi-armed bandit apparatus selects K−1 arms, C(t), according to the UCB index.

TABLE 13

| | Arm 1 | Arm 2 | Arm 3 |
|---|---|---|---|
| uᵢ(1) | 1.0 | 1.0 | 0 |

| | |
|---|---|
| C(2) | Arm 1 is arbitrarily selected among Arm 1and Arm 2 having the |
| | highest UCB index of 1.0 |

3. The multi-armed bandit apparatus calculates the unfairness index as follows.

$$- {f}_{i} ( t - 1 ) : = {c}_{i} \cdot ( t - 1 ) - {n}_{i , t - 1}$$

TABLE 14

| | Arm 1 | Arm 2 | Arm 3 |
|---|---|---|---|
| fᵢ(1) | −0.6 | −0.6 | 0.4 |

4. The multi-armed bandit apparatus selects the remaining single arm, γ(t), as follows.
   F(2): {Arm 3}
   F(2)=Ø?
   γ(2): Among the arms in F(2), Arm 3 with the highest unfairness index is selected.
5. The multi-armed bandit apparatus collects K arms to be played as follows.
   Z(t):=C(t)∪{γ(t)}
   Z(2) Arm 1, Arm 3
6. The multi-armed bandit apparatus plays the selected arms as follows:

TABLE 15

| | |
|---|---|
| Z(2) | Arm 1, Arm 3 |

Play selected arms
↓ ↓
Sample rewards are generated

| | |
|---|---|
| Arm | Sample Reward (X_{i, n}_{_{i, t}}) |
| Arm 1 | 1 |
| Arm 3 | 1 |

7. The multi-armed bandit apparatus updates the number of arm selections and the empirical mean reward as follows.

$$- {n}_{i , t} : = \{ \begin{matrix}{n}_{i , t - 1} + 1 & for i ∈ Z ( t ) \\ {n}_{i , t - 1} & for i ∉ Z ( t )\end{matrix} ,$$

$$- {\hat{θ}}_{i , {n}_{i , t}} := \frac{{\sum }_{s = 1}^{{n}_{i , t}} {X}_{i , s}}{{n}_{i , t}} ,$$

$$∀ i ∈ Z ( t )$$

TABLE 16

| | Arm 1 | Arm 2 | Arm 3 | | | Arm 1 | Arm 2 | Arm 3 |
|---|---|---|---|---|---|---|---|---|
| {X_{i, k}}ₖ₌₁ⁿ^{_{i, 1}} | {1} | {1} | { } | Update | {X_{i, k}}ₖ₌₁ⁿ^{_{i, 2}} | {1, 1} | {1} | {1} |
| n_{i, 1} | 1 | 1 | 0 | → | n_{i, 2} | 2 | 1 | 1 |
| \hat{θ}_{i, n}_{_{i, 1}} | 1.0 | 1.0 | 0 | | \hat{θ}_{i, n}_{_{i, 2}} | 1.0 | 1.0 | 1.0 |

8. Fairness constraints are verified.
n_{i,t}≥└cᵢ·t┘ is verified to be true for t=3 as follows.

TABLE 17

| | | Arm 1 | Arm 2 | Arm 3 |
|---|---|---|---|---|
| NUmber or arm | n_{i, 3} | 2 | 2 | 2 |
| selections → | | | | |
| Minimum number of | └cᵢ · 3┘ | 1 | 1 | 1 |
| times arm should be → | | | | |
| selected to meet | | | | |
| fairness constraint | | | | |

As above, the operation examples of the multi-armed bandit method at time step t=1, 2 are shown. Then, the multi-armed bandit method at time step t=3, 4, . . . , 9 can be operated. In this way, during the total time step T (e.g., T=9), exactly K (e.g., K=2) arms can be selected from a total of M (e.g., M=3) arms at each time step.

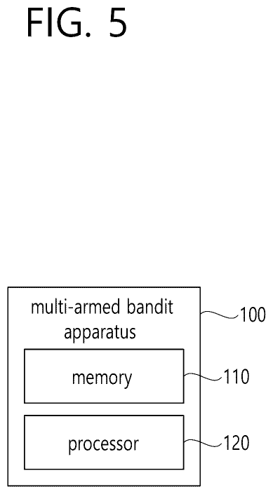

FIG. 5 is a block diagram of a multi-armed bandit apparatus for selecting multiple items while ensuring fairness of exposure of the multiple items and maximizing the averaged total reward according to one embodiment of the present disclosure.

As shown in FIG. 5, the multi-armed bandit apparatus 100 for selecting multiple items while ensuring fairness of exposure of items and maximizing the averaged total reward according to one embodiment of the present disclosure includes a memory 110 and a processor 120. However, not all of the components shown are essential components. The multi-armed bandit apparatus 100 for selecting multiple items while ensuring fairness of exposure of items and maximizing the averaged total reward may be implemented using more components than those shown, or may be implemented using fewer components than those shown to ensure fairness of exposure of items and selecting multiple items.

Hereinafter, the detailed configuration and operation of each component of the multi-armed bandit apparatus 100 for selecting multiple items while ensuring fairness of exposure of items and maximizing the averaged total reward, which is shown in FIG. 5, will be described.

The memory 110 stores one or more programs related to multi-armed bandit for selecting multiple items while ensuring fairness of exposure of items and maximizing the averaged total reward.

The processor 120 executes one or more programs stored in the memory 110. The processor 120 initializes the empirical mean reward and number of arm selections of each arm for the M arms, and the time step, wherein M is a total number of arms, increments the time step, calculates the upper confidence bound (UCB) index of each arm for the M arms, wherein the UCB index of each arm is calculated using its empirical mean reward and number of arm selections, selects K−1 arms with the K−1 highest UCB indices calculated, wherein K is a value less than M, calculates unfairness indices for the unchosen M−(K−1) arms, checks if there is an arm with a positive unfairness index among the unchosen M−(K−1) arms, selects the remaining single arm depending on whether there is an arm with a positive unfairness index among the unchosen M−(K−1) arms, plays the selected K arms, and updates the empirical mean reward and the number of arm selections for the played arms

According to embodiments, the K items are selected out of M items at each time step.

According to embodiments, for each time step t (1≤t≤T) and each arm i (1≤i≤M), a fairness constraint n_{i,t}≥└cᵢ·t┘ is satisfied, where n_{i,t} represents the number of times arm i to be played up to time step t, and cᵢ represents the minimum fraction of times that arm i should be played at least └cᵢ·t┘ times at time step t.

According to embodiments, When the unfairness index of arm i at time step t−1 for each arm i is defined as f_{i,t-1}, the processor 120 calculates the unfairness index of arm i at time step t−1 according to the following equation,

$${f}_{i , t - 1} : = {c}_{i} ( t - 1 ) - {n}_{i , t - 1} ,$$

$$∀ i ∈ [ M ]$$

The processor 120 calculates the UCB index of each arm for the M arms by applying any UCB index calculation method used in a single-play multi-armed bandit (MAB) algorithm.

When the processor 120 calculates the UCB1 index of arm i according to the following equation, the averaged regret has an upper bound of O(1) (a constant upper bound).

$${u}_{i} ( t - 1 ) := {\hat{θ}}_{i , {n}_{i , t - 1}} + \sqrt{\frac{2 ln ( t - 1 )}{{n}_{i , t - 1}}}$$

When the processor 120 calculates the KL-UCB index of arm i according to the following equation, the averaged regret has an upper bound of O(1) (a constant upper bound).

$${u}_{i} ( t - 1 ) : = max \{ q > {\hat{θ}}_{i , {n}_{i , t - 1}} \vert {n}_{i , t - 1} d ( {\hat{θ}}_{i , {n}_{i , t - 1}} , q ) \leq ln ( t - 1 ) + a ln ( ln ( t - 1 ) ) \}$$

where, a is a real number of a≥0, and d(p, q) means the Kullbeck-Leibler divergence for p being a real number of 0≤p≤1 and q being a real number of 0≤q≤1, and is defined as

$$d ( p , q ) = p ln \frac{p}{q} + ( 1 - p ) ln ( \frac{1 - p}{1 - q} ) .$$

When there is an arm with a positive unfairness index among the unchosen M−(K−1) arms, the processor 120 selects the arm with the highest positive unfairness index among the unchosen M−(K−1) arms.

When there is no arm with a positive unfairness index among the unchosen M−(K−1) arms, the processor 120 selects the arm with the highest UCB index among the unchosen M−(K−1) arms.

Meanwhile, the multi-armed bandit apparatus 100 according to the embodiments of the present disclosure relates to a fair multi-armed bandit (MAB) method of selecting multiple items that guarantees the fraction of the items, and MAB's biggest application field is recommender systems. Specific application examples include online advertising, product recommendation in e-commerce, music recommendation, movie/TV program recommendation, news article recommendation, travel destination recommendation, restaurant/delivery food recommendation, etc.

One application in which the embodiments of the present disclosure can be utilized is a product recommendation system in e-commerce. When showing multiple products to users on an e-commerce site, it is common to maximize the business operator's revenue by showing popular products. However, for various reasons (to respect the tastes of a few people, or for unpopular but public purposes), products that are not popular among people also need to be guaranteed exposure opportunities. Therefore, the embodiments of the present disclosure can be utilized to set cᵢ for ensuring the fraction for each product and to recommend as many products that are popular among people as possible so that sales are maximized while ensuring the number of recommendations for each product according to the preset cᵢ.

Another application in which the present disclosure can be utilized is an online advertising system. When placing an online advertisement on a site, multiple advertisements are placed on the site. Among the numerous advertisements, it is common to place advertisements that are of great interest to many users and are frequently clicked. However, in order to maintain market diversity and prevent monopoly by certain advertisers, it is also necessary to expose advertisements that are not often clicked. Therefore, the embodiments of the present disclosure can be utilized to set cᵢ for ensuring the fraction for each advertisement, and to place as many advertisements that are clicked on by many people as possible while ensuring the number of placements of each advertisement according to the preset cᵢ.

In addition to these applications, the embodiments of the present disclosure can be used to implement various recommendation systems that require guaranteed exposure to multiple items.

In addition, the embodiments of the present disclosure can be applied to finding secondary channels in cognitive radio, routing, finding medical methods/drugs suitable for patients, etc.

Meanwhile, according to one embodiment of the present disclosure, the various embodiments described above may be implemented as software including instructions stored in a machine-readable storage media that can be read by a machine (e.g., a computer). The machine is a device capable of calling instructions stored from a storage medium and operating according to the called instructions, and may include an electronic device (e.g., electronic device A) according to the disclosed embodiments. When the instructions are executed by a processor, the processor may perform the function corresponding to the instructions directly or using other components under the control of the processor. The instructions may include code generated or executed by a compiler or interpreter. The storage medium that can be read by the machine may be provided in the form of a non-transitory storage medium. In this case, ‘non-transitory’ only means that the storage medium does not include signals and is tangible, without distinguishing whether the data is stored semi-permanently or temporarily in the storage medium.

Further, according to one embodiment of the present disclosure, the method according to the various embodiments described above may be provided and included in a computer program product. The computer program product is a commodity and may be traded between a seller and a buyer. The computer program product may be distributed in the form of a machine-readable storage medium (e.g. compact disc read only memory (CD-ROM)) or online through an application store (e.g. Play Store™). In the case of online distribution, at least a portion of the computer program product may be at least temporarily stored or created temporarily in a storage medium such as the memory of a manufacturer's server, an application store's server, or a relay server.

In addition, according to one embodiment of the present disclosure, the various embodiments described above may be implemented in a recording medium that can be read by a computer or similar device using software, hardware, or a combination thereof. In some cases, the embodiments described herein may be implemented in a processor itself. According to software implementation, embodiments such as procedures and functions described in the present specification may be implemented as separate software modules. Each of the software modules may perform one or more functions and operations described herein.

Meanwhile, computer instructions for performing processing operations of devices according to the various embodiments described above may be stored in a non-transitory computer-readable medium. The computer instructions stored in such a non-transitory computer-readable medium, when executed by a processor of a specific device, cause the specific device to perform processing operations in the device according to the various embodiments described above. The non-transitory computer-readable medium refers to a medium that stores data semi-permanently and can be read by a device, rather than a medium that stores data for a short period of time, such as registers, caches, and memories. Specific examples of the non-transitory computer-readable media may include CD, DVD, hard disk, Blu-ray disk, USB, memory card, ROM, etc.

In addition, each component (e.g., module or program) according to the various embodiments described above may be composed of a single or multiple entities, and some of the sub-components described above may be omitted, or other sub-components may be further included in the various embodiments. Alternatively or additionally, some components (e.g., modules or programs) may be integrated into a single entity and perform the same or similar functions performed by each corresponding component prior to integration. Operations performed by the module, program, or other component according to the various embodiments may be executed sequentially, in parallel, iteratively, or heuristically, or at least some operations may be executed in a different order, omitted, or other operations may be added.

While preferred embodiments of the present disclosure have been shown and described above, the present disclosure is not limited to the specific embodiments described above, and various modifications may be made by one of ordinary skill in the art without departing from the gist of the present disclosure as claimed in the claims, and such modifications should not be understood in isolation from the technical ideas or views of the present disclosure.

What is claimed is:

1. A multi-armed bandit (MAB) method for selecting multiple items while ensuring fairness of exposure of the multiple items and maximizing the averaged total reward, which is performed by a multi-armed bandit apparatus, wherein each item is referred to as an arm when there are multiple items, the method comprising:
initializing the empirical mean reward and number of arm selections of each arm for the M arms, and the time step, wherein M is a total number of arms;
incrementing the time step;
calculating the upper confidence bound (UCB) index of each arm for the M arms, wherein the UCB index of each arm is calculated using its empirical mean reward and number of arm selections;
selecting K−1 arms with the K−1 highest UCB indices calculated, wherein K is a value less than M;
calculating unfairness index of each arm for the unchosen M−(K−1) arms;
checking if there is an arm with a positive unfairness index among the unchosen M−(K−1) arms;
selecting the remaining single arm depending on whether there is an arm with a positive unfairness index among the unchosen M−(K−1) arms;
playing the selected K arms; and
updating the empirical mean reward and the number of arm selections for the played arms.

2. The multi-armed bandit method of claim 1, wherein the K items are selected out of M items at each time step.

3. The multi-armed bandit method of claim 1, wherein for each time step t (1≤t≤T) and each arm i (1≤i≤M), a fairness constraint n_{i,t}≥└cᵢ·t┘ is satisfied, where n_{i,t} represents the number of times arm i to be played up to time step t, and cᵢ represents the minimum fraction of times that arm i should be played at least └cᵢ·t┘ times at time step t.

4. The multi-armed bandit method of claim 1, wherein in the calculating of the unfairness indices, when the unfairness index of arm i at time step t−1 for each arm i is defined as f_{i,t-1}, the unfairness index of arm i at time step t−1 is calculated according to the following equation,
$${f}_{i , t - 1} : = {c}_{i} ( t - 1 ) - {n}_{i , t - 1} ,$$
$$∀ i ∈ [ M ]$$

5. The multi-armed bandit method of claim 1, wherein in the calculating of the UCB index, the UCB index of each arm for the M arms is calculated by applying any UCB index calculation method used in a single-play multi-armed bandit (MAB) algorithm.

6. The multi-armed bandit method of claim 1, wherein in the calculating of the UCB index, when the UCB1 index of arm i is calculated according to the following equation, the averaged regret has an upper bound of O(1) (a constant upper bound).
$${u}_{i} ( t - 1 ) := {\hat{θ}}_{i , {n}_{i , t - 1}} + \sqrt{\frac{2 ln ( t - 1 )}{{n}_{i , t - 1}}}$$

7. The multi-armed bandit method of claim 1, wherein in the calculating of the UCB index, when the KL-UCB index of arm i is calculated according to the following equation, the averaged regret has an upper bound of O(1) (a constant upper bound).
$${u}_{i} ( t - 1 ) : = max \{ q > {\hat{θ}}_{i , {n}_{i , t - 1}} \vert {n}_{i , t - 1} d ( {\hat{θ}}_{i , {n}_{i , t - 1}} , q ) \leq ln ( t - 1 ) + a ln ( ln ( t - 1 ) ) \}$$
where, a is a real number of a≥0, and d(p, q) means the Kullbeck-Leibler divergence for p being a real number of 0≤p≤1 and q being a real number of 0≤q≤1, and is defined as
$$d ( p , q ) = p ln \frac{p}{q} + ( 1 - p ) ln ( \frac{1 - p}{1 - q} ) .$$

8. The multi-armed bandit method of claim 1, wherein in the selecting of the remaining single arm, when there is an arm with a positive unfairness index among the unchosen M−(K−1) arms, the arm with the highest positive unfairness index among the unchosen M−(K−1) arms is selected.

9. The multi-armed bandit method of claim 1, wherein in the selecting of the remaining single arm, when there is no arm with a positive unfairness index among the unchosen M−(K−1) arms, the arm with the highest UCB index among the unchosen M−(K−1) arms is selected.

10. A multi-armed bandit (MAB) apparatus for selecting multiple items while ensuring fairness of exposure of the multiple items and maximizing the averaged total reward, wherein each item is referred to as an arm when there are multiple items, the apparatus comprising:
a memory storing one or more programs related to multi-armed bandit for selecting multiple items while ensuring fairness of exposure of items and maximizing the averaged total reward; and
a processor that executes the one or more stored programs,
wherein the processor is configured to:
initialize the empirical mean reward and number of arm selections of each arm for the M arms, and the time step, wherein M is a total number of arms,
increment the time step,
calculate the upper confidence bound (UCB) index of each arm for the M arms, wherein the UCB index of each arm is calculated using its empirical mean reward and number of arm selections,
select K−1 arms with the K−1 highest UCB indices calculated, wherein K is a value less than M,
calculate unfairness indices for the unchosen M−(K−1) arms,
check if there is an arm with a positive unfairness index among the unchosen M−(K−1) arms,
select the remaining single arm depending on whether there is an arm with a positive unfairness index among the unchosen M−(K−1) arms,
play the selected K arms, and
update the empirical mean reward and the number of arm selections for the played arms.

11. The multi-armed bandit apparatus of claim 10, wherein the K items are selected out of M items at each time step.

12. The multi-armed bandit apparatus of claim 10, wherein for each time step t (1≤t≤T) and each arm i (1≤i≤M), a fairness constraint n_{i,t}≥└cᵢ·t┘ is satisfied, where n_{i,t} represents the number of times arm i to be played up to time step t, and cᵢ represents the minimum fraction of times that arm i should be played at least └cᵢ·t┘ times at time step t.

13. The multi-armed bandit apparatus of claim 10, wherein when the unfairness index of arm i at time step t−1 for each arm i is defined as f_{i,t-1}, the processor calculates the unfairness index of arm i at time step t−1 according to the following equation,
$${f}_{i , t - 1} : = {c}_{i} ( t - 1 ) - {n}_{i , t - 1} ,$$
$$∀ i ∈ [ M ]$$

14. The multi-armed bandit apparatus of claim 10, wherein the processor calculates the UCB index of each arm for the M arms by applying any UCB index calculation method used in a single-play multi-armed bandit (MAB) algorithm.

15. The multi-armed bandit apparatus of claim 10, wherein when the processor calculates the UCB1 index of arm i according to the following equation, the averaged regret has an upper bound of O(1) (a constant upper bound).
$${u}_{i} ( t - 1 ) := {\hat{θ}}_{i , {n}_{i , t - 1}} + \sqrt{\frac{2 ln ( t - 1 )}{{n}_{i , t - 1}}}$$

16. The multi-armed bandit apparatus of claim 10, wherein when the processor calculates the KL-UCB index of arm i according to the following equation, the averaged regret has an upper bound of O(1) (a constant upper bound).
$${u}_{i} ( t - 1 ) : = max \{ q > {\hat{θ}}_{i , {n}_{i , t - 1}} \vert {n}_{i , t - 1} d ( {\hat{θ}}_{i , {n}_{i , t - 1}} , q ) \leq ln ( t - 1 ) + a ln ( ln ( t - 1 ) ) \}$$
where, a is a real number of a≥0, and d(p, q) means the Kullbeck-Leibler divergence for p being a real number of 0≤p≤1 and q being a real number of 0≤q≤1, and is defined as
$$d ( p , q ) = p ln \frac{p}{q} + ( 1 - p ) ln ( \frac{1 - p}{1 - q} ) .$$

17. The multi-armed bandit apparatus of claim 10, wherein when there is an arm with a positive unfairness index among the unchosen M−(K−1) arms, the processor selects the arm with the highest positive unfairness index among the unchosen M−(K−1) arms.

18. The multi-armed bandit apparatus of claim 10, wherein when there is no arm with a positive unfairness index among the unchosen M−(K−1) arms, the processor selects the arm with the highest UCB index among the unchosen M−(K−1) arms.
